(19) United States
(12) Patent Application Publication
(10) Pub. No.: US 2015/0286390 A1
(43) Pub. Date: Oct. 8, 2015

(54) Music Player, Automatic Skin-Replacing Method and System Thereof, and Computer-Readable Storage Medium

(71) Applicant: Tencent Technology (Shenzhen) Company Limited, Guangdong (CN)

(72) Inventors: Rui Wang, Guangdong (CN); Wei Liu, Guangdong (CN); Mingli Dong, Guangdong (CN); Bo Jiang, Guangdong (CN); Shilei Liu, Guangdong (CN)

(73) Assignee: Tencent Technology (Shenzhen) Company Limited, Guangdong (CN)

(21) Appl. No.: 14/590,655

(22) PCT Filed: Sep. 11, 2013
(86) PCT No.: PCT/CN2013/083332

§ 371 Date: Jan. 6, 2015

(30) Foreign Application Priority Data
Sep. 19, 2012 (CN) 201210349226.3

(51) Int. Cl. G06F 3/0484

(52) U.S. Cl. CPC G06F 3/04847; G06F 3/04842

(57) ABSTRACT

An automatic skin-replacing method of a music player and system thereof, and a music player and computer-readable storage medium thereof are disclosed. The automatic skin-replacing method of a music player, including: matching a music file in a music player to a corresponding skin; and switching, when the music file being played by the music player, current skin of the music player to the skin matching to the music file. When a music file being played by the music player, current skin of the music player can be switched to a skin matching to the music file by matching the music file in a music player to the corresponding skin, eliminating the need to manually set by a user, which is convenient, and the skin display can be switched depending on the song played, which makes the way for changing skin of the music player more flexible.

### CROSS REFERENCE TO RELATED APPLICATIONS

This application is a national stage application of, and claims priority to, International Application No. PCT/CN2013/083332, filed Sep. 11, 2013, which claims priority to Chinese Patent Application No. CN 201210349226.3, filed Sep. 19, 2012.

### FIELD

The present disclosure relates generally to the technical field of music play, and more particularly, to an automatic skin-replacing method of a music player and system thereof, and a music player and computer-readable storage medium thereof.

### BACKGROUND

Music player software is a commonly-used application in a computer, an intelligent terminal and other intelligent devices. Generally, a music player provides a variety of selectable skins for a user to choose by specifying options.

The skin of a common music player on client is set in a way that: opening, by a user, the music player; entering the settings of the music player; and, selecting one skin from multiple alternative skins as a current skin. However, once this done, the music player will keep the selected skin unchanged until the user opens the settings again to set the skin. That is, every time the user wants to set the skin of the music player, he/she has to set the options manually. This is not only tedious, but also monotonous in the skin to be presented after each setting.

### SUMMARY

In view of the problems existing in the prior art, it is an object of the present disclosure to provide an automatic skin-replacing method of a music player by which the skin of the music player can be automatically replaced without tedious operations, and to provide an automatic skin-replacing system of a music player.

An automatic skin-replacing method, including:

matching a music file in a music player to a corresponding skin; and

switching, when the music player is playing the music file, current skin of the music player to the skin matching to the music file.

An automatic skin-replacing system, including:

a matching module, configured to match a music file in a music player to a corresponding skin; and

a switching module, configured to switch, when the music player is playing the music file, current skin of the music player to the skin matching to the music file.

It is a further object of the present disclosure to provide a music player. The music player has an automatic skin-replacing system of a music player according to the present disclosure by which the skin of the music player can be automatically replaced without tedious operations.

The automatic skin-replacing method and system of a music player, and the music player, match a music file in a music player to a corresponding skin, and switch current skin of the music player to the skin matching to the music file when the music player is playing the music file. As a result, skins can be auto-changed according to different songs, eliminating the need to manually set by a user and being convenient. In addition, the skin display can be switched depending on the song being played, which makes the way for changing skin of the music player more flexible.

### BRIEF DESCRIPTION OF THE DRAWINGS

FIG. 1 is a flow diagram showing an automatic skin-replacing method of a music player in accordance with certain embodiments of the present disclosure.

FIG. 2 is a schematic diagram illustrating an automatic skin-replacing system of a music player in accordance with certain embodiments of the present disclosure.

FIG. 3 is a schematic diagram illustrating a section of a terminal device based on the present disclosure.

FIG. 4 is a schematic diagram illustrating a section of a server based on the present disclosure.

### DETAILED EMBODIMENTS

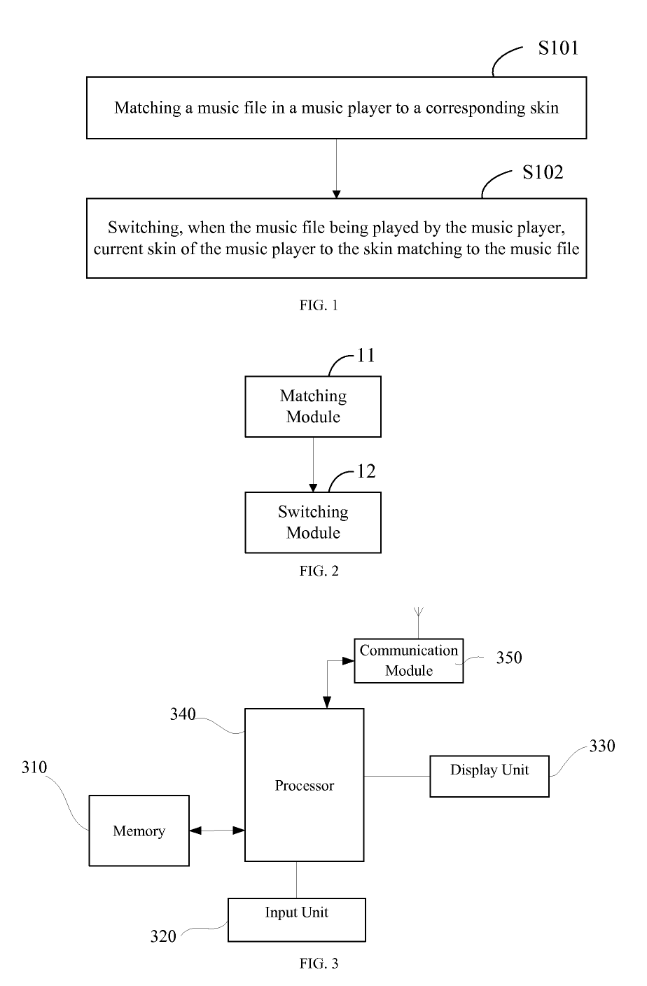

Please refer to FIG. 1, which is a flow diagram showing an automatic skin-replacing method of a music player in accordance with certain embodiments of the present disclosure.

The automatic skin-replacing method of a music player may include:

Step S110, a skin with a corresponding music file in a music player;

In this step, preferably, match a playlist containing a plurality of music files in the music player to a skin that the skin matching to the playlist may be used when a music file in the playlist is played. In addition, a skin may be matched to the corresponding playlist depending on a music type, an album name or a singer corresponding to the playlist, and may be also matched to the playlist by the user through customizing skins.

Matching a skin to a corresponding music file in the music player may be achieved by the music player through automatic search for skin files, that is, the music player automatically searches, in a local skin repository of the music player, for a skin stored matching to the music file. If there is a skin that matches with the music file stored in the local skin repository of the music player, the skin may be directly acquired, or a skin matching to the music file may be searched for in a skin repository of a server to be downloaded locally.

There may be a plurality of downloaded or included skin files stored in the local skin repository of the music player, which may be set by settings. When a music file is to be matched with a corresponding skin, the local skin repository may be searched for at first to find out whether there is a corresponding skin file, and if there is a skin file that matches with the music file stored in the local skin repository, the skin file may be used directly, or a corresponding skin file may be searched for in the server to be downloaded locally for application.

The present disclosure further provides a method for searching for skins matching to individual music files as below.

Firstly, set corresponding tags indicating different music types to each of the skin. The tag of music type may be automatically added by the server, or may be input by the user in the local music player. The tag of music type includes music style (such as rock, pop, lyric and so on), area (such as Europe, America, Hong Kong, Macao and so on), singer, album, etc.

Determine the music type of the corresponding music file, and search for a skin that has a corresponding tag indicating the music type of the music file for matching according to the music type of the music file, when matching the skin file. For example, if the music type of the music file is rock, a corresponding skin file that has a tag of music type of rock will be searched for and matched to the music file. The way to determine the music type of the music file may be achieved by setting a tag of music type to each music file or by other common means in the prior art.

The way to match a music file in a music player with a corresponding skin may be achieved in the music player, or may be achieved by a server. If the matching of the skin file is achieved by the server, when the music player downloads a corresponding music file from the server, the music player would also download a skin bound to the music file in the server. In this case, music files and skin files are directly and uniformly matched on the server end, without the need for locally matching by the music player, which is more convenient.

The way to match a music file in a music player with a corresponding skin may be achieved by the function of skin customization of the music player, that is, the music player receives an instruction for customizing a skin corresponding to the music file, acquires a local picture specified, edits the local picture into a skin of the music player, and matches the skin to the music file. Through the above approaches, a variety of pictures may be customized as skins of the music player by a user, and may be matched and bound to corresponding music files, to enhance the personalization of the music player. The way for user customization also applies to a playlist created by the user, that is, when the music player receives an instruction for creating a playlist, it crates the playlist and provides an option of skin customization in a configuration window of creating the playlist for the user to choice a skin in local or in a server, or to edit a custom skin, to match the playlist.

Step S102, when the music player is playing the music file, current skin of the music player to the skin matching to the music file.

In this step, determine whether the current skin of the music player is the skin matching to the music file being played, and if so, the switching module leaves the current skin without switching, otherwise, the switching module switches the current skin to the skin matching to the music file.

That means when finished playing a music file, if the skin matches with the next music file is different with the skin matches with the previous music file, the skin of music player may be switched automatically, to achieve an automatic switch of skin of the music player depending on the song.

If a playlist is provided with a matched skin, the switching module leaves the current skin without switching before all of songs in the playlist have been played, and after ending the playlist, the skin of the music player may be switched as soon as the next playlist starts to be played.

If there are two or more skins those match with the music file, when the music file is played, one of the skins may be randomly selected to be switched as the current skin of the music player, and optionally, the skin of the music player may be switched between the two or more skins in turn at a predetermined time interval. The above design also applies to the case of playlist.

The automatic skin-replacing method of a music player according to the present disclosure matches a music file in a music player to a corresponding skin, and switches current skin of the music player to the skin matching to the music file when the music file being played by the music player. As a result, the skin can be auto-changed according to a song, eliminating the need to manually set by a user, which is convenient, and the skin display can be switched depending on the song played, which makes the way for changing skin of the music player more flexible.

Further, the music player may be added an option to set the auto-changing of skin that if the option of auto-changing of skin is triggered, the auto-changing of skin may start, otherwise, the auto-changing of skin may not start.

By the automatic skin-replacing method of a music player in accordance with certain embodiments of the present disclosure, the skin of the music player may be changed according to the album played or the type of the played song, to better enhance the user experience as a little surprise during listening to music. In addition, it may add interest to configure the skin when the user is listening to or searching for a song, without getting bored of researching, so as to giving a greater sense of control and make a better experience for the user when playing music.

Please refer to FIG. 2, which is a flow diagram showing an automatic skin-replacing system of a music player in accordance with certain embodiments of the present disclosure.

The automatic skin-replacing system of a music player includes: a matching module 11 and a switching module 12. The matching module 11 is configured to match a music file in a music player to a corresponding skin; and the switching module 12 is configured to switch, when the music player is playing the music file, current skin of the music player to the skin matching to the music file.

Preferably, the matching module 11 may be configured to match a playlist containing a plurality of music files in the music player to a skin that the skin matching to the playlist may be used when a music file in the playlist is played. The matching module 11 may match a skin to the corresponding playlist depending on a music type, an album name or a singer corresponding to the playlist, and may also set a skin that matches with the playlist by a user through customizing skins.

The matching module 11 may match a skin to a corresponding music file in the music player in a way that the music player searches for skin files automatically, that is, the music player automatically searches whether there is a skin that matches with the music file stored in a local skin repository of the music player. If there is a skin that matches with the music file stored in the local skin repository of the music player, the skin may be directly acquired, or a skin that matches with the music file may be searched for in a skin repository of a server to be downloaded locally.

There may be a plurality of downloaded or included skin files stored in the local skin repository of the music player, which may be set by settings. When a music file is to be matched with a corresponding skin, the local skin repository may be searched for at first to find out whether there is a corresponding skin file, and if there is a skin file that matches with the music file stored in the local skin repository, the skin file may be used directly, or a corresponding skin file may be searched for in the server to be downloaded locally for application.

In one preferred embodiment, the matching module 11 sets for each skin a corresponding tag indicating a music type. The tag of music type may be automatically added by the server, or may be input by the user in the local music player. The tag of music type includes music style (such as rock, pop, lyric and so on), area (such as Europe, America, Hong Kong, Macao and so on), singer, album, etc.

The matching module 11 determines the music type of the corresponding music file, and searches for a skin that has a corresponding tag indicating the music type of the music file for matching according to the music type of the music file, when matching the skin file. For example, if the music type of the music file is rock, a corresponding skin file that has a tag of music type of rock will be searched and matched to the music file. The way to determine the music type of the music file may be achieved by setting a tag of music type to each music file or by other common means in the prior art.

The way to match a music file in a music player with a corresponding skin by the matching module 11 may be achieved in the music player, or may be achieved by a server. If the matching of the skin file is achieved by the server, the matching module 11 is included in the server end, and when the music player downloads a corresponding music file from the server, the music player would also download a skin bound to the music file in the server. In this case, music files and skin files are directly and uniformly matched on the server end, without the need for locally matching by the music player, which is more convenient.

The way to match a music file in a music player with a corresponding skin by the matching module 11 may be achieved by the function of skin customization of the music player, that is, the music player receives an instruction for customizing a skin corresponding to the music file, acquires a local picture specified, edits the local picture into a skin of the music player, and matches the skin to the music file. Through the above approaches, a variety of pictures may be customized as skins of the music player by a user, and may be matched and bound to corresponding music files, to enhance the personalization of the music player. The way for user customization also applies to a playlist created by the user, that is, when the music player receives an instruction for creating a playlist, it crates the playlist and provides an option of skin customization in a configuration window of creating the playlist for the user to choice a skin in local or in a server, or to edit a custom skin, to match the playlist.

The switching module 12 determines whether the current skin of the music player is the skin matching to the music file being played, and if so, the switching module leaves the current skin without switching, otherwise, the switching module switches the current skin to the skin matching to the music file.

That means when finished playing a music file, if the skin matches with the next music file is different with the skin matches with the previous music file, the switching module 12 automatically switches the skin of music player to achieve an automatic switch of skin of the music player depending on the song.

If the matching module 11 sets a skin that matches with the playlist, the switching module 12 may not switch the skin of the music player before all of songs in the playlist have been played, and after ending the playlist, the switching module 12 may switch the skin of the music player as soon as the next playlist starts to be played.

If there are two or more skins those match with the music file, when the music file is played, one of the skins may be randomly selected by the switching module 12 to be switched as the current skin of the music player, and optionally, the skin of the music player may be switched between the two or more skins in turn by the switching module 12 at a predetermined time interval. The above design also applies to the case of playlist.

The automatic skin-replacing system of a music player matches a music file in a music player to a corresponding skin, and switches current skin of the music player to the skin matching to the music file when the music file being played by the music player. As a result, the skin can be auto-changed according to a song, eliminating the need to manually set by a user, which is convenient, and the skin display can be switched depending on the song played, which makes the way for changing skin of the music player more flexible.

The present disclosure also seeks to protect a music player which has an automatic skin-replacing system of a music player according to the present disclosure that the skin of the music player can be auto-changed depending on the music file, eliminating the need to manually set by a user, which is convenient, to provide an improved user experience.

It will be appreciated for those skilled in the art that parts of or overall process in the above embodiments and the corresponding system and the music player can be implemented by related hardware controlled by computer program, the computer program can be stored in a non-transitory computer-readable storage medium, and when the computer program is executed, it can include the processes of the above embodiments of each method. Wherein, the non-transitory computer-readable storage medium can be a disc, a compact disc, a Read-Only Memory or a Random Access Memory. Thus, according to the above embodiments of the present disclosure, the present disclosure also provides a non-transitory computer-readable storage medium comprising an executable program that any of the above methods for auto-changing skin of a music player according to the present disclosure may be achieved when the executable program in the non-transitory computer-readable storage medium is executed.

The method in accordance with certain embodiments of the present disclosure as mentioned above may be installed on an appropriate device in the form of software, and the above process of auto-changing skin of a music player may be achieved by controlling an associated device when the software is running. Accordingly, the above client end may be installed in an appropriate terminal device, or may be the appropriate terminal device itself. The terminal device described herein may be a mobile phone, a tablet, a PDA (Personal Digital Assistant), a POS (Point of Sales), an Auto PC, etc. The above server end may be installed in an appropriate server that provides upgraded service, or may be the appropriate server that provides upgraded service itself.

The present disclosure hereby also provides a terminal device and a server, based on the above method for auto-changing skin of a music player and a system thereof in accordance with certain embodiments of the present disclosure. The terminal device may be a mobile phone, a tablet, a PDA (Personal Digital Assistant), a POS (Point of Sales), an Auto PC or any kind of terminal device in which related software may need to be upgraded.

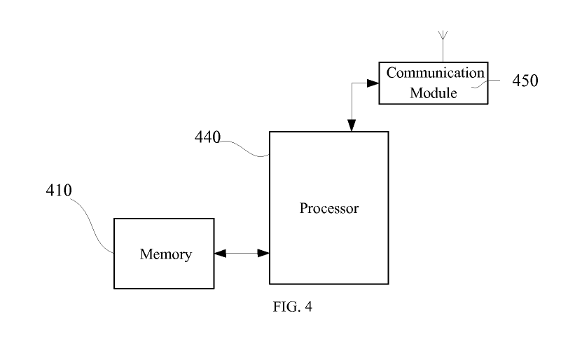

It hereby takes a kind of terminal device for example. FIG. 3 shows a section of the terminal device. As shown in FIG. 3, the terminal device includes a memory 310, an input unit 320, a display unit 330, a processor 340 and a communication module 350. It will be appreciated for those skilled in the art that the structure shown in FIG. 3 is only a section of the terminal device that is related to the embodiments of the present disclosure, and is not a limitation to the terminal device that may used in a solution according to the present disclosure. A specific terminal device may include more or less parts than those in the drawing, or combine some parts, or have a different arrangement of parts.

Every part of the terminal device will be specifically described in conjunction with FIG. 3.

The memory 310 may be configured to store a software program and a module. The processor 340 may execute each kind of function application and data processing related to the terminal device by running the software program stored in the memory 310. The memory 310 may mainly include a code area for storing an operating system, at least one application needed for a function and others, and a data area for storing data created according to the use of the terminal device. In addition, the memory 310 also includes a high speed random access memory, or a nonvolatile memory, for example, at least one of disk storage device, flash memory or other non-volatile solid state memories.

The input unit 320 may be configured to receive the input number, character or other information, and create a key signal input related to options and function control of the terminal device. Specifically, in one embodiment of the present disclosure, in the case of matching a skin to the music file by customization, a custom instruction defined by the user may be received by the input unit 320.

Specifically, it takes an example of mobile phone. The input unit 320 may include a touch panel and other input devices. The touch panel, also known as a touch screen, may gather touch operations (for example, the operation on or near the touch panel by a user through a finger, a touch pen or any appropriate object or accessory) thereon or nearby, and drive a corresponding connection device according to a predefined program. Optionally, the touch panel includes two parts: a touch detection device and a touch controller. The touch detection device is configured to detect the position of touch of the user and a signal brought by the touch operation, and to transmit the signal to the touch controller. The touch controller may receive the touch information from the touch detection device, convert the information into coordinates of touch spot, and send the coordinates to the processor 340. The touch controller may also receive command from the processor 34 for execution. In addition, the touch panel may be achieved by resistance-type, capacitance-type, infrared ray, surface acoustic wave and other kinds of touch. In addition to the touch panel, the input unit 320 may also include other input devices. Specifically, the other input devices include but do not limit to one or more of physical keyboard, function keys (such as volume button, switch button and so on), trackball, mouse, joystick or the like.

The display unit 330 may be configured to display the information input by the user or provided for the user and various menu. The display unit 330 may include a display panel, and optionally the display panel may be configured in the form of LCD (Liquid Crystal Display), OLED (Organic Light-Emitting Diode). Specifically, in one embodiment, a corresponding interface and a skin of the music player may be displayed by the display unit 330, and the information of switching the skin of the music player may also be displayed for giving a message to the user, allowing the user to determine the matching of a music file and a corresponding skin.

The terminal device may communicate with the server by the communication module 350 which may be implemented in any possible way, such as WiFi module, bluetooth communication, optical fiber communications and so on. Communication between the terminal device and the server through the communication module 350 allows the terminal device to send relevant information (taking one embodiment of the present disclosure for example, a request for searching for a skin that matches with a music file sent to the server) to the server, and receive relevant information from the server (for example, data of skin that matches with the music file returned from the server).

The processor 340 is a control center of the terminal device, which makes use of various interfaces and lines to connect each part of the whole terminal device, executes each kind of function and data processing of the terminal device by running or executing a software program and/or a module stored in the memory 310 and calling data stored in the memory 310, so as to achieve an overall monitor of the terminal device. Optionally, the processor 340 may includes one or more processing units.

Similarly, FIG. 4 shows a section of a server in accordance with certain embodiments of the present disclosure. As shown in FIG. 4 the server includes a memory 410, a processor 440 and a communication module 450. It will be appreciated for those skilled in the art that the structure shown in FIG. 4 is only a section of the server that is related to the embodiments of the present disclosure, and is not a limitation to the terminal device that may used in a solution according to the present disclosure. A specific server may include more or less parts than those in the drawing, or combine some parts, or have a different arrangement of parts.

The memory 410 may be configured to store a software program and a module. The processor 440 may execute each kind of function application and data processing related to the server by running the software program stored in the memory 410, for example, based on a search request, search for a skin file that matches with the music file. The memory 410 may mainly include a code area for storing an operating system, at least one application needed for a function (for example, analyze which skin file matches with the music file) and others, and a data area for storing data created according to the use of the server.

The server may communicate with the terminal device by the communication module 450, which may be implemented in any possible way, such as WiFi module, bluetooth communication, optical fiber communications and so on. Communication between the terminal device and the server through the communication module 450 allows the server to receive relevant information from the terminal device (taking one embodiment of the present disclosure for example, receive a request for searching for a skin file), and return corresponding information to the terminal device (for example, issue an already-matched skin file of the music player).

The processor 440 is a control center of the server, which makes use of various interfaces and lines to connect each part of the whole server, executes each kind of function and data processing of the server by running or executing a software program and/or a module stored in the memory 410 and calling data stored in the memory 410, so as to achieve an overall monitor of the server. Optionally, the processor 440 may includes one or more processing units.

Although the invention herein has been described with reference to various embodiments, it is to be understood that the embodiments are merely illustrative of the principles and applications of the present invention. It is therefore to be understood that a number of variations and modifications may be made to the illustrative embodiments without departing from the inventive spirit and scope of the present disclosure. Accordingly, the scope of the present disclosure is defined by the appended claims rather than the foregoing description and the exemplary embodiments described therein.

What is claimed is:

1. An automatic skin-replacing method of a music player, comprising:
matching a music file in a music player to a corresponding skin; and
switching, when the music file being played by the music player, current skin of the music player to the skin matching to the music file.

2. The method of claim 1, wherein the matching comprises:
matching a playlist containing a plurality of music files in the music player to a skin.

3. The method of claim 1, wherein the matching comprises:
searching, in a local skin repository of the music player, for a skin stored matching to the music file; and
acquiring the skin if the corresponding skin is found; otherwise, searching in a skin repository of a server for a skin matching to the music file, and downloading the skin.

4. The method of claim 1, wherein the searching comprises:
setting for each skin a corresponding tag indicating a music type;
determining a music type of the music file; and
searching, according to the music type of the music file, for a skin with a corresponding tag indicating the music type of the music file, and matching.

5. The method of claim 1, wherein the matching comprises:
downloading, by the music player, a skin bound to the music file in the server when downloading a music file from a server.

6. The method of claim 1, wherein the matching comprises:
receiving an instruction for customizing a skin corresponding to the music file; and
acquiring a local picture specified, editing the local picture into a skin of the music player, and matching the skin to the music file.

7. The method of claim 1, wherein the switching comprises:
determining whether the current skin of the music player is the skin matching to the music file being played being played; and
if so, leaving the current skin without switching, otherwise, switching the current skin to the skin matching to the music file.

8. The method of claim 1, wherein the switching comprises:
selecting randomly, from two or more corresponding skins matching to the music file, one of the skins, and switching the current skin of the music player to the skin selected; or switching at a predetermined time interval, the current skin of the music player between the two or more skins alternatively.

9. An automatic skin-replacing system of a music player, comprising:
a matching module, configured to match a music file in a music player to a corresponding kin; and
a switching module, configured to switch, when the music file being played by the music player, current skin of the music player to the skin matching to the music file.

10. The system of claim 9, wherein the matching module is configured to match a playlist containing a plurality of music files in the music player to a skin.

11. The system of claim 9, wherein the matching module searches, in a local skin repository of the music player, for a skin stored matching to the music file; and acquires the skin if the corresponding skin is found; otherwise, searches in a skin repository of a server for a skin matching to the music file, and downloads the skin.

12. The system of claim 11, wherein the matching module sets for each skin a corresponding tag indicating a music type; determines a music type of the music file; and searches, according to the music type of the music file, for a skin with a corresponding tag indicating the music type of the music file, and matches.

13. The system of claim 9, wherein the matching module downloads a skin bound to the music file in a server when the music player downloads a music file from a server.

14. The system of claim 9, wherein the matching module receives an instruction for customizing a skin corresponding to the music file, acquires a local picture specified, edits the local picture into a skin of the music player, and matches the skin to the music file.

15. The system of claim 9, wherein the switching module determines whether the current skin of the music player is the skin matching to the music file being played; and
if so, the switching module leaves the current skin without switching, otherwise, the switching module switches the current skin to the skin matching to the music file.

16. The system of claim 9, wherein the switching module selects randomly, from two or more corresponding skins matching to the music file, one of the skins, and switches the current skin of the music player to the skin selected; or switches at a predetermined time interval, the current skin of the music player between the two or more skins alternatively

17. A music player, comprising an automatic skin-replacing system of a music player according to claim 9.

18. (canceled)
